(19) United States
(12) Patent Application Publication
(10) Pub. No.: US 2008/0006799 A1
(43) Pub. Date: Jan. 10, 2008

(54) Method for producing a fire retardant gel and product made thereby

(76) Inventor: Bob Fowle, Bolton (CA)

Correspondence Address: MEREK, BLACKMON & VOORHEES, LLC, 673 S. WASHINGTON ST., ALEXANDRIA, WV, 22314, US

(21) Appl. No.: 11/480,983

(22) Filed: Jul. 6, 2006

(51) Int. Cl. C09K 21/00

(52) U.S. Cl. 252/601

(57) ABSTRACT

A method for producing a fire retardant gel. The method comprises the steps of forming a first solution comprised of a mixture of water and modified cellulose ether where the first solution has a pH of 7 or less; forming a second solution comprised of a mixture of water and a base where the second solution has an alkaline pH; and, mixing the first and the second solutions together in proportions such that the mixture of the first and the second solutions has an alkaline pH thereby causing the formation of the fire retardant gel at an accelerated rate.

### FIELD OF THE INVENTION

This invention relates generally to fire retarding materials, and in particular to a method for producing a fire retardant gel and a gel made by such a method.

### BACKGROUND OF THE INVENTION

Universally, water has been the most commonly used substance to fight fires. Water is used to both extinguish burning fires and to help prevent or limit the spread of flames from one structure or area to another. When a fire is sprayed with water the water has the tendency to reduce temperatures to below that of the combustion or ignition temperature of the material in question and also helps to act to deprive the fire of oxygen. As a result, spraying water upon a burning fire can be an effective way to extinguish the fire provided that sufficient water supplies are available.

Unfortunately, spraying water upon adjacent structures or areas to help prevent or limit the transmission of flames is considerably less efficient. Many structures (for example the exterior cladding or roof of a house or building) are generally designed to repel water. Accordingly, when attempting to prevent the transmission of flames to such a structure spraying its exterior with water tends to result in the water running off with an insufficient quantity being taken up or retained by the structure to prevent the transmission of flames for any significant length of time. Any small amount of water that soaks into the structure is often quickly evaporated by the heat of an adjacent fire, leaving the structure vulnerable to becoming engulfed, or alternatively requiring that a constant supply of water be sprayed over its surface. In order to address such problems others have proposed the use of a variety of different additives that may be mixed with water to enhance its fire fighting and fire preventing capabilities. Such additives and their methods of their manufacture and use are described in U.S. Pat. No. 3,976,580, dated Aug. 24, 1976; U.S. Pat. No. 5,190,110, dated Mar. 2, 1993; U.S. Pat. No. 5,518,638, dated May 21, 1996; U.S. Pat. No. 5,989,446, dated Nov. 23, 1999; U.S. Pat. No. 6,245,252, dated Jun. 12, 2001; and U.S. Pat. No. 6,776,920, dated Aug. 17, 2004.

While such additives, mixtures and their methods of use may present certain advantages over the use of pure water when fighting fires and when attempting to prevent the spread of fire to adjacent structures, they also suffer from a number of inherent limitations, not the least of which is their cost. Additives that may be mixed with water to produce an effective fire fighting agent will often have little real benefit if their costs are so high that it becomes impractical to utilize them in large quantities, as are often required when fighting typical residential or commercial fires. In some instances the additives may also cause environmental problems or concerns, making them less attractive for wide spread use. Environmental concerns surrounding the use of particular additives are particularly important when fighting forest fires. In yet other instances, the additives when mixed with water may require extensive modifications to existing fire fighting equipment in order to apply them to a burning or adjacent structure due to their high viscosity, etc.

There is therefore a need for a fire retarding or fire fighting product that is of assistance when both fighting fires and when attempting to prevent the transmission of flames to adjacent structures, that is relatively inexpensive to manufacture, that is generally devoid of environmental concerns, that is readily available, and that can be easily utilized with conventional fire fighting equipment without the need for extensive modifications.

### SUMMARY OF THE INVENTION

The invention therefore provides a method for producing a fire retardant gel and a gel that is made through the employment of such a method wherein the gel may be used for purposes of both fighting fires and to coat adjacent structures to help prevent a fire from spreading.

Accordingly, in one of its aspects the invention provides a method for producing a fire retardant gel, the method comprising the steps of forming a first solution comprised of a mixture of water and modified cellulose ether, said first solution having a pH of 7 or less; forming a second solution comprised of a mixture of water and a base, said second solution having an alkaline pH; and, mixing said first and said second solutions together in proportions such that said mixture of said first and second solutions has an alkaline pH, thereby causing the formation of said fire retardant gel at an accelerated rate.

In a further aspect the invention provides a fire retardant gel made in accordance with the described method.

The invention also concerns a method of preventing the transmission of flames from a fire to a non-burning structure, the method comprising spraying the non-burning structure with a fire retardant gel, the fire retardant gel formed through mixing a first solution with a second solution by pumping said first and second solutions through a nozzle such that said gel forms at an accelerated rate upon said first and said second solutions exiting said nozzle so that when said nozzle is directed toward the non-burning structure gel is deposited thereon, said first solution comprised of a mixture of water and modified cellulose ether and having a pH of 7 or less, said second solution comprised of a mixture of water and a base and having an alkaline pH, said first and said second solutions mixed together in proportions such that the resulting mixture has an alkaline pH.

Further aspects and advantages of the invention will become apparent from the following description taken together with the accompanying drawings.

### BRIEF DESCRIPTION OF THE DRAWINGS

For a better understanding of the present invention, and to show more clearly how it may be carried into effect, reference will now be made, by way of example, to the accompanying drawings which show the preferred embodiments of the present invention in which:

FIG. 1 is an illustration of one preferred system that may be utilized to produce the fire retardant gel of the current invention; and,

FIG. 2 is an illustration of an alternate system that may be used for the production of the fire retardant gel of the present invention.

### DESCRIPTION OF THE PREFERRED EMBODIMENT

The present invention may be embodied in a number of different forms. However, the specification and drawings that follow describe and disclose only some of the specific forms of the invention and are not intended to limit the scope of the invention as defined in the claims that follow herein.

The current invention is generally premised upon the concept of combining two liquid components that when mixed together form a gel that may be sprayed onto a fire to help extinguish the fire, or that may be sprayed upon an adjacent structure to help retard the spread of the fire. The physical properties of the gel are such that it will exhibit a tendency to remain in place on vertical or sloped surfaces and will be less inclined to merely run off onto the ground, as is the case when using water. From a thorough understanding of the invention it will be appreciated that through the adjustment of particular properties of one or both of the liquids (and primarily their pH's) the method of the present invention can be tailored to produce a gel within a matter of seconds (or less) from the mixing of the two liquids, to a number of minutes, as desired under particular circumstances. It will also be appreciated that the liquids in question may be kept separate and mixed by pumping through a nozzle or similar device such that the gel is effectively formed as the liquids are sprayed upon a fire or other surface, thereby permitting the use of standard fire fighting and pumping equipment with the need for only relatively minor modifications.

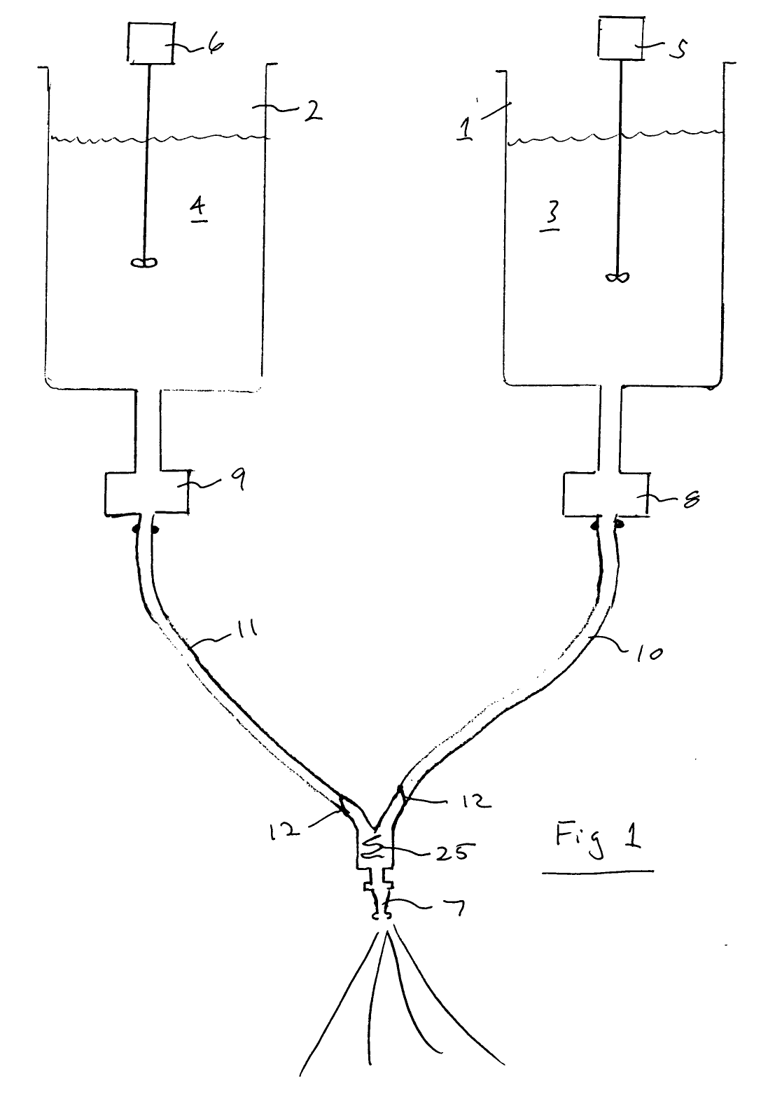

With reference to FIG. 1 there is shown in schematic form an illustration of one form of equipment that may be used to carry out the inventive method. FIG. 1 shows two tanks or vessels, 1 and 2 respectively, that hold a first solution 3, in the case of tank 1, and a second solution 4, in the case of tank 2. It will be appreciated that depending upon the particular application and the desired volumes of fire retardant gel to be created, the relative sizes of tank 1 and tank 2 could vary substantially.

In accordance with a preferred embodiment of the invention first solution 3 in tank 1 will be comprised of a mixture of water and modified cellulose ether (MCE) and preferably has a pH ranging from acidic to neutral (i.e. 7 or less). In a more preferred embodiment the pH of solution 3 will be approximately 7. It has been found that the lower or more acidic the pH of first solution 3 the longer the time that the solution will remain stable before transforming into a gelatinous state on its own. With a pH of approximately 7 or less first solution 3 will remain generally stable for 45 minutes or longer, which is felt to be a sufficient length of time for most application. However, if a longer stability time is required one merely need to reduce the pH of first solution 1 making it more acid. For example, with a pH of approximately 3.5 first solution 3 will be stable for approximately 3.5 hours.

The modified cellulose ether (MCE) in solution 3 will preferably be from about 2% to about 20% by weight of the first solution, and most preferably approximately 10% by weight of the first solution. Generally, the higher the weight percent of the MCE the higher the viscosity of the gel that will ultimately be produced. The MCE can be any one of a wide variety of different commercially available products. In a preferred embodiment the MCE is comprised of one or more of hydroxypropyl methylcellulose, hydroxyethyl cellulose, vegetable gum and guar gum. One particular commercially available cellulose product that has been found to be effective is CELLOSIZE™ (QP100MH) by the Dow Chemical Company. To maintain the uniformity of the water and MCE mixture within tank 1, an agitator or mixing device 5 may be utilized. Pursuant to the invention, second solution 4 in tank 2 is comprised of a mixture of water and a base such that the second solution has an alkaline pH. A variety of different bases may be used, however, in most instances it is expected that the base will be ammonium hydroxide and will comprise from approximately 0.1% to approximately 1% by weight of the second solution. In a more preferred embodiment of the invention the pH of second solution 4 will be approximately 10. As in the case of tank 1, tank 2 may also be fitted with an agitation or mixing device 6 in order to maintain solution 4 in a generally uniform state.

It has been found that the MCE and water mixture that comprises solution 3 when maintained at a neutral or acidic pH will generally remain in a liquid form for an extended length of time. However, upon raising the pH of the liquid to above the neutral point the physical structure of solution 3 changes such that it enters into a gelatinous state having a viscosity that generally ranges from approximately 250,000 centipoise to approximately 40 million centipoise. It will be appreciated by those skilled in the art that the precise viscosity of the gelatinous product and its rate of formation will be a function of a variety of different factors which include the weight percent of MCE present in solution 3. The pH of each of solutions 3 and 4, the pH of the mixture of the two solutions, the proportions of the two solutions that are mixed together, the temperature of the solutions, and the length of time that transpires from the point that the pH is raised to above neutral will also generally affect gelling time. For example, increasing the pH of the mixture of solutions 3 and 4 has the effect of causing the mixture to change into a gel at an accelerated rate, as does an increase in temperature. In these regards the following table sets forth the approximate time between an increase in the pH of the mixture of the two solutions and its transformation into a gel or gelatinous structure, for a given weight percent of MCE.

| Approximate | Approximate Time | |
|---|---|---|
| pH | To Formation of Gel | |
| 3.53 | 3.5 | hours |
| 7.03 | 45 | minutes |
| 9.85 | 30 | seconds |
| 10.15 | 5 | seconds |
| 11.10 | 1 | second |

In order for the product made by the method of the present invention to be utilized in fire fighting situations, in a preferred embodiment of the invention the mixing of first and second solutions 3 and 4 is accomplished by pumping the solutions through a nozzle 7. As shown in FIG. 1 a pair of pumps, 8 and 9 respectively, preferably draw the respective solutions from tanks 1 and 2 and pump them through individual hoses or conduits 10 and 11 that are joined at or immediately before nozzle 7 so that the first and second solutions may be mixed together at the nozzle. The flow rates of pumps 8 and 9 can be controlled to allow for a desired proportional mixing of solutions 3 and 4. To enhance the mixing of the two solutions a static mixer 25 may be placed immediately upstream from the nozzle so that the solutions are first fed through mixer 25 and then into nozzle 7. Preferably a pair of check valves 12 are placed within each of hoses 10 and 11 to prevent the possibility of back flow of either solution 4 into tank 2, or solution 3 into tank 1, and the unintentional formation of a gel in either the hoses, the pumps or the respective tanks.

While it will be understood that the pressure that pumps 8 and 9 generate will once again be dependent upon the particular application at hand, in most cases it is expected that relatively significant pressures of 100 pounds per square inch or more will be utilized, thereby resulting in a thorough mixing of solutions 3 and 4 at mixer 25 and nozzle 7. The relatively high pressure will also ensure a rapid expulsion of the mixed solutions from the nozzle and out of the system. Under such circumstances even at a rapid rate of gel formation no significant conversion of the mixed solutions into a gelatinous state will occur until they exit the end of the nozzle. In such cases the likelihood of reducing flow or plugging the nozzle is minimized. At the same time, setting the pH of second solution 4 at approximately 10 will ensure that the conversion of the mixed solutions into a gelatinous state occurs within a very few seconds of the solutions exiting the nozzle and either immediately before or immediately after being sprayed upon a surface. Forming the gel upon the exiting of the mixed solutions from the nozzle has been found to be advantageous for a number of reasons, including the elimination for specialized high pressure pumps that are required to pump a gel.

It will be appreciated by those skilled in the art that under certain circumstances it may be desirable to alter particular physical characteristics of a gel formed in accordance with the present invention. For example, where the gel is to be used on a horizontal surface for purposes of fire prevention it may not be as necessary to have as short of a gel formation time as the situation where the gel is to be sprayed upon a vertical surface. As indicated, for such applications adjusting the pH of second solution 4 will alter the time between mixing and the formation of a gelatinous structure. Further, when fighting oil fires or attempting to prevent oil spills on water from igniting, it may be desirable to add one or more density reducing additives to one or both of first solution 3 and second solution 4 to decrease the specific gravity of the resulting gel to less than that of water or oil. To reduce the density of the gel a wide variety of density reducing additives could be utilized, including hollow glass beads and microspheres. In other instances it may be advantageous for the resulting gel to have a bright or distinctive colour so that the degree of its application to a surface can be readily determined. Accordingly one or more colouring agents may be added to one or both of first solution 3 and second solution 4 so that the resulting gel is produced with a distinct and discernable colour. Finally, when fighting hydrocarbon or chemical fires it is sometimes advantageous to use a foam type product. Adding one or more surfactants to one or both of first solution 3 and second solution 4 and pumping the solutions through a nozzle will result in the formation of a gel that in effect has a “foam” like structure and consistency.

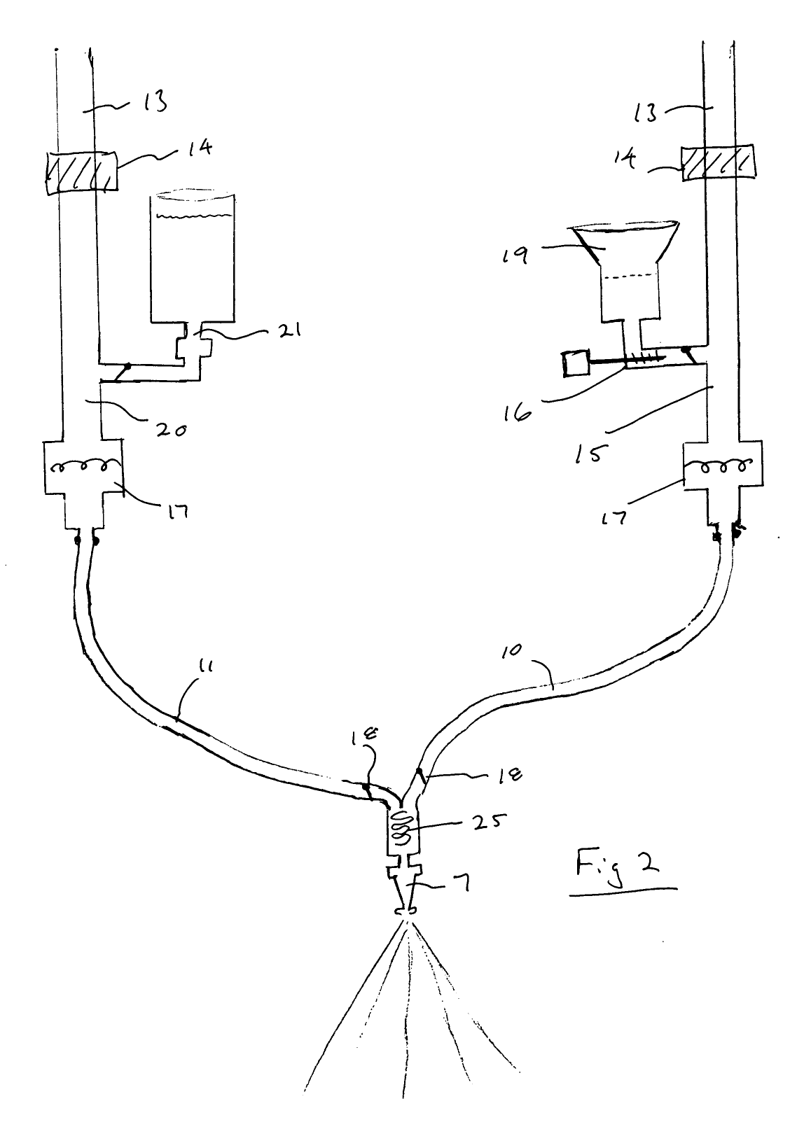

FIG. 2 shows an alternate structure to that as shown in FIG. 1, and one that may also be utilized to carry out the method of the present invention. In general, FIG. 2 is what may be referred to as an in-line mixing system, as opposed to the tank system shown in

FIG. 1. That is, unlike FIG. 1 the system shown in FIG. 2 does not utilize large tanks containing the first and second solutions. Instead, FIG. 2 is generally comprised of two parallel circuits, one dedicated to first solution 3 and one dedicated to second solution 4. Each circuit contains a water supply conduit 13 that feeds a pump 14 that draws water into the circuit and eventually pushes solutions 3 and 4, respectively, through a spray head or nozzle 7. The rate of flow for each solution through its respective circuit can be controlled through controlling the rate of each of the two pumps. It will be understood by those skilled in the art that in most instances a common water supply will feed pumps 14. It will also be appreciated that in an alternate embodiment a single pump may be used to draw water from a source, with the pressurized pump outflow split between the two circuits shown in FIG. 2. In such instances it may be desirable to place throttling valves, chokes or other flow control devices in the two circuits in order to control the relative movement of water and solutions therethrough.

Regardless of the manner in which water is pressurized and pushed through the first solution and the second solution circuits, in-line injection systems are incorporated into each circuit in order to blend the desired additives with the water. In the case of the circuit dedicated to the production of first solution 3, as shown in FIG. 2 the circuit preferably includes a storage vessel 19 containing a supply of MCE material (which in most instances will be a dry powder) that is added to first solution conduit 15 through the use of a metered injection machine 16. The injection machine may be one of any wide variety of commonly available types of equipment that are designed to add a desired quantity of powdered material to a moving stream of pressurized fluid. The turbulent flow of water through first solution conduit 15 will have the natural tendency of mixing the MCE with the water to form first solution 1. Nevertheless, in the preferred embodiment shortly after the MCE is injected into the moving stream of water it passes through a mixing or agitation device 17 to further ensure a thorough and complete mixing of the two components. Mixing or agitation device 17 may be mechanical and driven by an electric, hydraulic or pneumatic power source or, alternatively, may be a sheer mixing device that utilizes the pressurized flow of fluid through an orifice or conduit. Depending upon the nature of metered injection device 16, it may be necessary to install a check valve 18 in the MCE injection line to prevent pressurized fluid from flowing back into storage vessel 19.

Referring to the second of the two circuits shown in FIG. 2 (dedicated to the production of second solution 4), there is shown a second solution conduit 20 to which is connected a metered injection device 21 for purposes of adding a metered amount of sodium hydroxide or other base to water as it flows through conduit 20. While various types of injection devices could be used, typically metered injection device 21 will be comprised of a metered injection pump with the sodium hydroxide in a concentrated aqueous form such that adjustment of the pump's flow rate will permit a desired pH to be obtained within second solution 4.

Upon exiting first solution conduit 15 and second solution conduit 20 the first and second solutions are directed through pipes or hoses 10 and 11, just as in the embodiment shown in FIG. 1. From there the respective solutions proceed through a mixer and spray head or nozzle where they are combined and expelled, once again in a similar fashion to that as described above with reference to the structure shown in FIG. 1. A pair of check valves 12 help to prevent any back flow or inter-mixing of the solutions within hoses 10 and 11.

It will be appreciated from a thorough understanding of the invention that there is provided a method for forming a fire retardant gel wherein the gel is the result of the mixing of two solutions that are expelled through a nozzle or spray head. Since low viscosity liquid, as opposed to a high viscosity gel, is pumped through the nozzle standard pumps commonly found on most fire fighting equipment may be utilized. Unlike other prior art gels, the gel of the present invention does not require the presence of high concentrations of carbon dioxide or an extended length of time in order to form. Further, the stiffness or viscosity of the gel may be easily and quickly adjusted to suit its end use and application. For example, where the gel is to be sprayed upon vertical walls of a building, a fast forming high viscosity gel may be created. In other applications where the gel is to be sprayed upon the ground or a horizontal surface adjustments to the mixing equipment and the concentration of difference components of the gel may be made to create a less viscous or slower setting product. It has also been found that the gel has a tendency to remain in place when heated and does not “run” like some existing products. As explained, the variation of the pH of the second solution permits an operator to adjust the gelling time of the combined mixture from approximately one second to 45 minutes, or longer. It will further be appreciated that due to the relatively low toxicity of the gel the method and its resulting product may have applications outside of the field of firefighting. For example, the product could be used for crowd control in place of traditional water sprayed through water cannons.

It is to be understood that what has been described are the preferred embodiments of the invention and that it may be possible to make variations to these embodiments while staying within the broad scope of the invention. Some of these variations have been discussed while others will be readily apparent to those skilled in the art.

I claim:

1. A method for producing a fire retardant gel, the method comprising the steps of:
(i) forming a first solution comprised of a mixture of water and modified cellulose ether, said first solution having a pH of 7 or less;
(ii) forming a second solution comprised of a mixture of water and a base, said second solution having an alkaline pH; and,
(iii) mixing said first and said second solutions together in proportions such that the mixture of said first and said second solutions has an alkaline pH thereby causing the formation of said fire retardant gel at an accelerated rate.

2. The method as claimed in claim 1 including the further step of adjusting the rate of the formation of said gel resulting from the mixing of said first and said second solutions through adjusting the pH of said second solution.

3. The method as claimed in claim 1 including the further step of adjusting the rate of the formation of said gel resulting from the mixing of said first and said second solutions through adjusting the pH of one of said first and said second solutions.

4. The method as claimed in claim 2 including the step of adding one or more density reducing additives to one or both of said first and said second solutions, said density reducing additives decreasing the specific gravity of said gel to less than that of water.

5. The method as claimed in claim 4 wherein said density reducing additives are microspheres.

6. The method as claimed in claim 2 wherein said step of mixing said first and said second solutions is accomplished by pumping said solutions through a nozzle, said gel formed upon said mixture of said first and said second solutions exiting the nozzle.

7. The method as claimed in claim 2 wherein said step of mixing said first and said second solutions is accomplished by pumping said solutions through a static mixer.

8. The method as claimed in claim 1 including the further step of adding one or more colouring agents to one or both of said first and said second solutions, said one or more colouring agents resulting in the production of a gel having a desired colour.

9. The method as claimed in claim 1 including the further step of adding one or more surfactants to one or both of said first and said second solutions, said step of mixing said first and said second solutions comprising pumping said solutions through a nozzle, said gel formed through said mixing of said first and said second solutions having a foam-like structure.

10. The method as claimed in claim 1 wherein said base is ammonium hydroxide.

11. The method as claimed in claim 1 wherein said modified cellulose ether is from about 2 percent to about 20 percent by weight of said first solution and said base is ammonium hydroxide and comprises from about 0.1 percent to about 1 percent by weight of said second solution.

12. The method as claimed in claim 1 wherein said modified cellulose ether is comprised of hydroxypropyl methylcellulose, hydroxyethyl cellulose, vegetable gum and guar gum.

13. The method as claimed in claim 12 wherein said gel has a viscosity of from about 250,000 centipoise to about 40 million centipoise.

14. The method as claimed in claim 1 wherein the pH of said first solution is approximately 7 and the pH of said second solution is approximately 10.

15. The method as claimed in claim 1 including the further step of heating one or both of said first and said second solutions to further accelerate the formation of said gel.

16. The method as claimed in claim 1 wherein said gel is formed within approximately one second or less from the mixing of said first and second solutions.

17. A fire retardant gel made in accordance with the method of any one of claims 1 through 16.

18. A method of preventing the transmission of flames from a fire to a non-burning structure, the method comprising spraying the non-burning structure with a fire retardant gel, the fire retardant gel formed through mixing a first solution with a second solution by pumping said first and second solutions through a nozzle whereby said gel forms at an accelerated rate upon said first and said second solutions exiting said nozzle so that when said nozzle is directed toward the non-burning structure gel is deposited thereon, said first solution comprised of a mixture of water and modified cellulose ether and having a pH of 7 or less, said second solution comprised of a mixture of water and a base and having an alkaline pH, said first and said second solutions mixed together in proportions such that the resulting mixture has an alkaline pH.
